(19) United States
(12) Patent Application Publication
(10) Pub. No.: US 2017/0141573 A1
(43) Pub. Date: May 18, 2017

(54) DEVICE MANAGEMENT IN AN ELECTRIC POWER GRID

(71) Applicant: Reactive Technologies Limited, Oxford (GB)

(72) Inventors: Timo LINNA, Oulu (FI); Ville PAJU, Oulu (FI); Heikki HUOMO, Oulu (FI)

(21) Appl. No.: 15/355,963

(22) Filed: Nov. 18, 2016

Related U.S. Application Data
(63) Continuation of application No. PCT/EP2015/061216, filed on May 21, 2015.

(30) Foreign Application Priority Data
May 21, 2014 (GB) 1409057.5

(51) Int. Cl. H02J 3/14; H02J 3/38

(52) U.S. Cl. CPC H02J 3/14; H02J 3/383; H02J 3/386

(57) ABSTRACT

Methods and apparatuses for controlling one or more electricity characteristics of electricity flowing in an electric power grid are described. Data indicative of a control function representing characteristics of a contribution to the one or more electricity characteristics to be made by a distributed plurality of power units during a control period is provided to the distributed plurality of power units. The power units individually determine and provide a contribution to the one or more electricity characteristics based on the received control function and profile information relating to the power units. This saves processing resources at the central location providing the control function and/or communications bandwidth/resources.

### CROSS-REFERENCE TO RELATED APPLICATIONS

This application is a continuation of International Application No. PCT/EP2015/061216, filed May 21, 2015, which claims the benefit of GB Application No. 1409057.5, filed May 21, 2014. Each of the above-referenced patent applications is incorporated by reference in its entirety.

### BACKGROUND OF THE INVENTION

Field of the Invention

The present invention relates to management of devices in an electricity distribution network. In particular, but not exclusively, it relates to control of devices that consume and/or provide energy to the network.

Description of the Related Technology

Supply of electricity from power generators, such as power stations, to consumers, such as domestic households and businesses, typically takes place via an electricity distribution network. FIG. 1 shows an exemplary distribution network comprising a transmission grid 100 and a distribution grid 102. The transmission grid 100 is connected to generating plants 104, which may be nuclear plants or gas-fired plants, for example, from which it transmits large quantities of electrical energy at very high voltages (in the UK, for example, this is typically of the order of 204 kV; however this varies by country), using power lines such as overhead power lines, to the distribution grid 102; although, for conciseness, only one distribution grid 102 is shown here, in practice a typical transmission grid supplies power to multiple distribution grids. The transmission grid 100 is linked to the distribution grid 102 via a transformer 106 which converts the electric supply to a lower voltage (in the UK, for example, this is typically of the order of 50 kV; however, this varies by country) for distribution in the distribution grid 102. The distribution grid 102 in turn links, via substations 108 comprising further transformers for converting to still lower voltages, to local networks such as a city network 112 supplying domestic users 114, and to industrial consumers such as a factory 110. Smaller power generators such as wind farms 116 may also be connected to the distribution grid 102, and provide power thereto.

In some circumstances it is desirable to manage operational characteristics of power consumption and/or provision devices. For example, the total power consumption associated with a given network varies considerably from time to time; for example, peak consumption periods may occur during the hottest part of the day during summer, when many consumers use their air conditioning units or during winter with electric heating. There may also be considerable variation in demand for electrical energy between different geographical areas; it may be difficult to supply the required amount of electric energy to areas of high demand, known as “hot spots”, resulting in potential power cuts in these areas, increased peaker-plant generation, and/or an inefficient distribution of network resources.

Similarly, other characteristics of electricity flowing in the distribution grid 102, such as frequency, or reactive power characteristics, may experience undesirable variations due to, for example, a sudden loss of power provision from a power station or other source.

Prior art methods include providing electricity consumers with pricing and other information, with the user being required to monitor an energy tariff on e.g. a smart meter, and respond to price signals from an electricity supplier. However, this places considerable burden on the user performing the monitoring.

Other approaches have included methods of remotely monitoring electricity consumption devices in the network at a central location, and sending commands, for example, to disable the devices during times of high demand. However, coordination of the operation of multiple devices from a central location can place considerable strain on the processing resources at the central location and/or communications bandwidth/resources.

It is an object of the present invention to at least mitigate at least some of the problems of the prior art.

### SUMMARY

In accordance with a first aspect of the invention, there is provided method of controlling one or more electricity characteristics of electricity flowing in an electric power grid, the electric power grid being connected to a distributed plurality of power units each arranged to consume electric power from and/or provide electric power to the electric power grid, the method comprising: receiving, at a first power unit of the distributed plurality of power units, instructions to control power consumption from, and/or provision to, the electric power grid, the instructions including data indicative of a control function representing characteristics of a contribution to the one or more electricity characteristics to be made by the distributed plurality of power units during a control period; retrieving, from a data store, profile information indicating one or more characteristics of a contribution that the first power unit is available to make during the control period; determining, at the first power unit, based on the control function and the profile information, a first power unit contribution to the one or more electricity characteristics to be made by the first power unit during the control period; and controlling power consumption from and/or provision to the electric power grid in accordance with the first power unit contribution.

In accordance with a second aspect of the invention, there is provided a computer program comprising instructions to perform, on a computerized device, a method according to the first aspect.

In accordance with a third aspect of the invention, there is provided a control device to control a power unit to perform a method according to the first aspect.

In accordance with a fourth aspect of the invention, there is provided a method for controlling one or more real or reactive electricity characteristics of electricity flowing in an electric power grid, the electric power grid being connected to a distributed plurality of power units each arranged to consume electric power from and/or provide electric real or reactive power to the electric power grid, the method comprising: determining, at a control system, a contribution to be made to one or more electricity characteristics by a plurality of power units each arranged to consume electric power from and/or provide electric power to the electric power grid during a control period; selecting, at the control system, a first plurality of the distributed plurality of power units based on the determined contribution and profile information relating to the first plurality of power units, the profile information including information relating to one or more operating characteristics of the power units; generating, at the control system, a control function providing a representation of characteristics of the determined contribution; and sending, via a communication means of the control system, instructions to the first plurality of power units to control power consumption and/or provision, the instructions including an indication of the control function.

In accordance with a fifth aspect of the present invention, there is provided a computer program comprising instructions to perform, on a computerized device, a method according to the fourth aspect.

In accordance with a sixth aspect of the present invention, there is provided a control system arranged to perform a method according to the fourth aspect.

In accordance with a seventh aspect of the present invention, there is provided a control system for controlling one or more electricity characteristics of electricity flowing in an electric power grid, the electric power grid being connected to a distributed plurality of power units each arranged to consume electric power from and/or provide electric power to the electric power grid, the control system comprising: a processing means; and a communication means, wherein the processing means is arranged to: determine a contribution to be made to the one or more electricity characteristics by a plurality of power units each arranged to consume electric power from and/or provide electric power to the electric power grid during a control period; select a first plurality of the distributed plurality of power units based on the determined contribution and profile information relating to the first plurality of power units, the profile information including information relating to one or more operating characteristics of the power units; generate a control function providing a representation of characteristics of the determined time-varying contribution; and send, via the communication means, instructions to the first plurality of power units to control power consumption and/or provision, the instructions including an indication of the control function.

In accordance with an eighth aspect of the present invention, there is provided a method for controlling one or more characteristics of electricity flowing in an electric power grid, the electric power grid being connected to a distributed plurality of power units each arranged to consume electric power from and/or provide electric power to the electric power grid, the method comprising: determining, at a control system, a time-varying contribution to be made to the one or more characteristics by a plurality of power units each arranged to consume electric power from and/or provide electric power to the electric power grid during a control period; selecting, at the control system, a first plurality of the distributed plurality of power units based on the determined contribution and profile information relating to the first plurality of power units, the profile information including information relating to one or more operating characteristics of the power units; sending, via a communication means of the control system, instructions to each of the first plurality of power units to control power consumption and/or provision during the control period, wherein the instructions sent to a given one of the first plurality power units include a frequency-domain representation of a time-varying contribution to be made by the given power unit to the one or more characteristics.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a prior art electricity distribution network;

FIG. 2 shows a system comprising a central node, a plurality of control nodes and a plurality of power units, for implementing an embodiment of the present invention;

FIG. 3a shows an exemplary power unit and a power unit control unit in accordance with an embodiment of the present invention;

FIG. 3b shows an example of the content of the data store of FIG. 3a;

FIG. 4 shows an example of the central node of FIG. 2;

FIG. 5 shows an example of the content of the user database of FIG. 4;

FIG. 6 shows a control node for use in accordance with an embodiment of the present invention;

FIG. 7 shows an exemplary device database for use in accordance with an embodiment of the present invention;

FIG. 8a is a flow diagram of an exemplary process performed at a control node for controlling one or more electricity characteristics of electricity flowing in an electric power grid in accordance with an embodiment of the present invention;

FIG. 8b is a flow diagram of an exemplary process performed at a power unit for controlling one or more electricity characteristics of electricity flowing in an electric power grid in accordance with an embodiment of the present invention;

FIG. 9 is a graph showing an exemplary control function for use in an embodiment of the present invention;

FIG. 10 is a graph showing an exemplary integrated control function for use in accordance with an embodiment of the present invention;

FIG. 11 shows the effect on a desired contribution of the a finite time length of the contribution from a power unit;

FIG. 12a is a graph showing a control function divided into intervals according to an embodiment of the present invention;

FIG. 12b shows a contribution being divided into multiple contributions according to an embodiment of the present invention;

FIG. 13 shows characteristics of an exemplary control function for use in accordance with an embodiment of the present invention; and

FIG. 14 shows a time-domain representation and two frequency-domain representations of a control function for use in accordance with embodiments of the present invention.

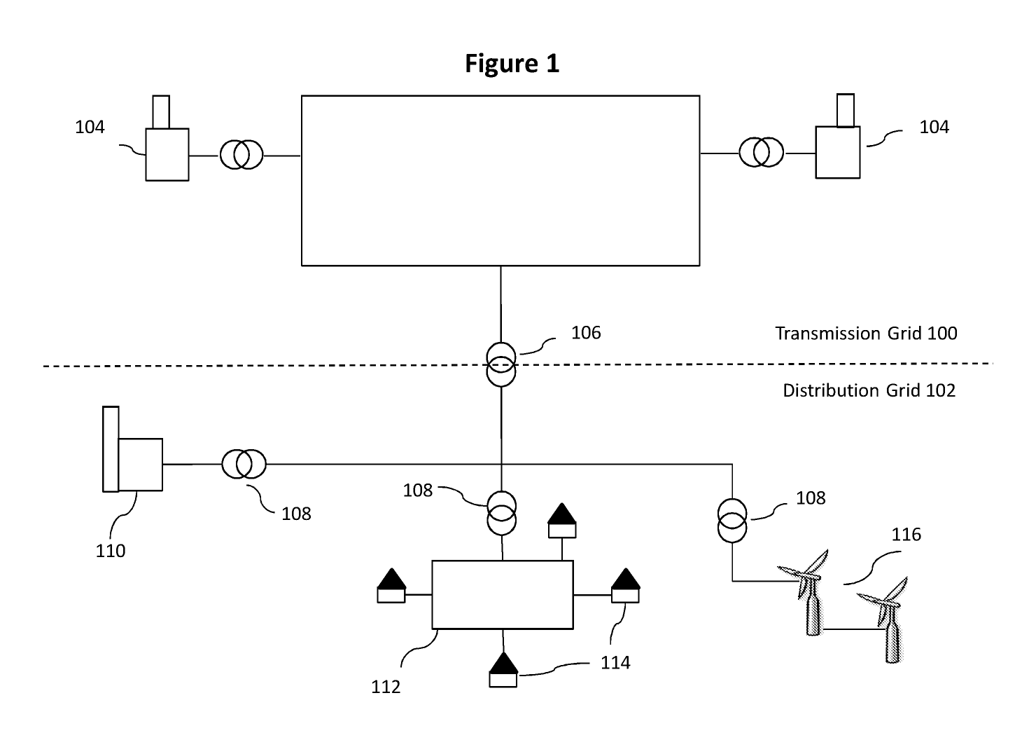

### DETAILED DESCRIPTION OF CERTAIN INVENTIVE EMBODIMENTS

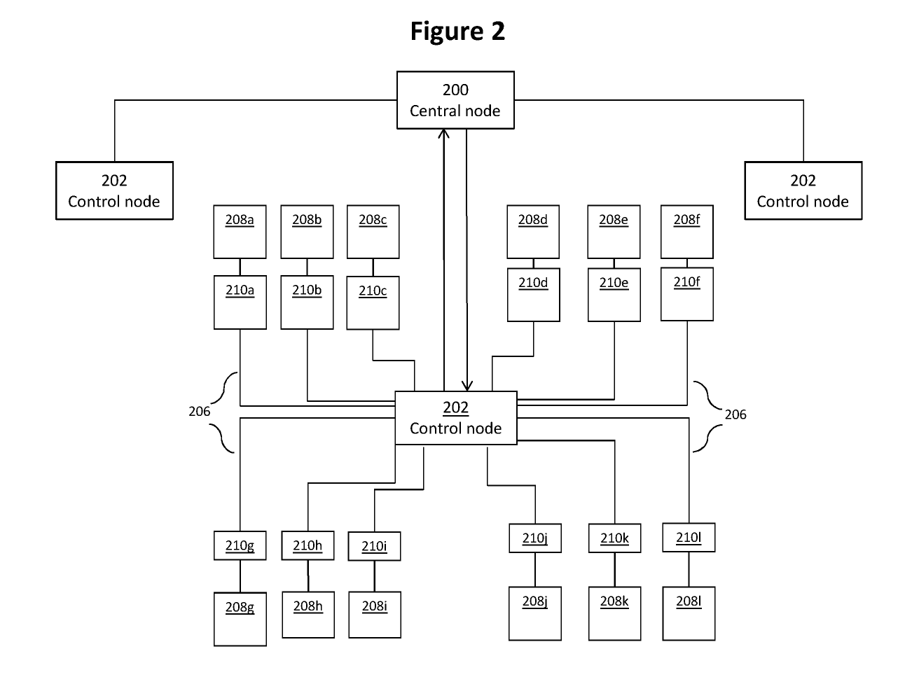

FIG. 2 illustrates an electricity distribution network in which an embodiment of the present invention may be implemented. The network comprises a central node 200 connected to one or more control nodes 202. The control nodes may each cover a geographical area, for example a country, region, state, postal-code, or electricity market region, or any other area comprising user premises (i.e. residences or workplaces). Each of the control nodes 202 are connected by power lines 206, via substations and/or distribution feeders, to energy consumption/provision devices 208a to 208l, hereinafter referred to as power units 208. Each of the power units 208a to 208l typically consumes and/or provides electric energy. Examples of power units 208 consuming electric energy include domestic appliances such as electric water heaters, air-conditioning units and washing machines, as well as industrial devices, such as factory machinery. Examples of providers of electric energy include generators of electric energy such solar panels and wind-turbines, and electricity storage devices such as batteries. Still other power units 208 may consume electric energy at some times but provide it at others, such as personal electric vehicles (PEVs); PEVs typically have the capacity to store a large amount of electricity, and may be connected to the electricity network when they are stationary, allowing them to be used as a source of power for the network at times of high demand, with electricity stored in the battery of the PEV being fed back to the network at such times.

The term “power unit” is used herein to include individual appliances or devices, as well as collections of such appliances and devices, such as a particular business premises or house. Each power unit 208a to 208l may be registered to a control scheme, in which the owner of the device gives permission to the control scheme operator to control energy transfer to/from the power unit 208a to 208l.

Although, for the sake of simplicity, only twelve power units 208a to 208l are shown in FIG. 2, it will be understood that, in practice, the network will typically comprise many hundreds or thousands of such devices.

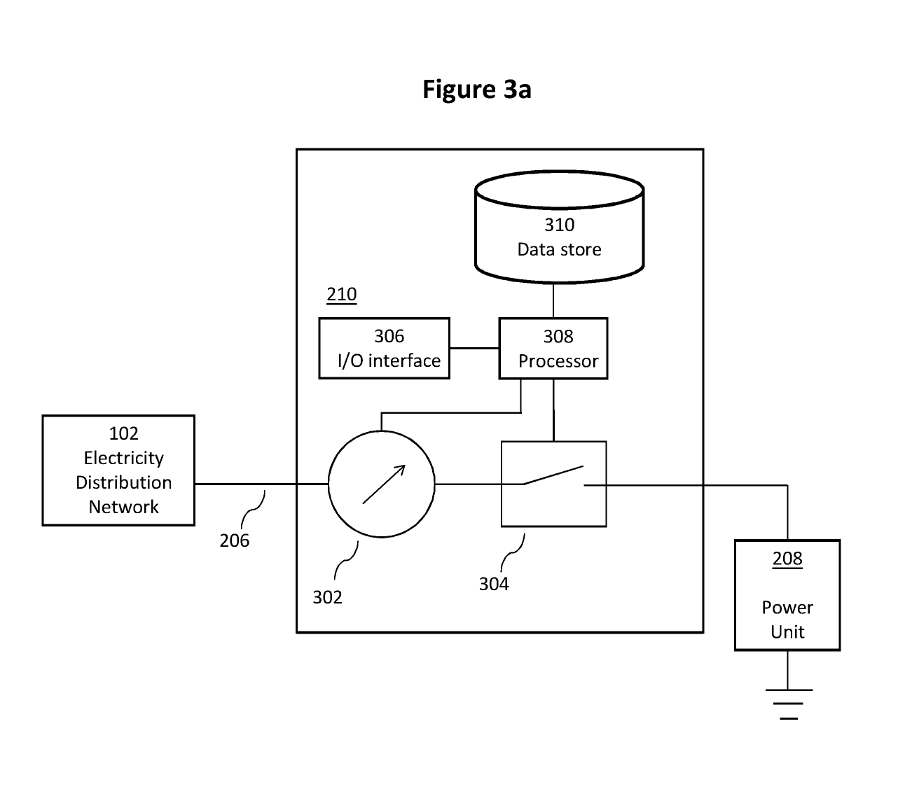

Each registered power unit 208a to 208l has an associated power unit control unit 210a to 2101 which controls transfer (i.e. provision and/or consumption) of energy to/from the power unit 208a to 208l. FIG. 3a shows an exemplary arrangement of a power unit 208 and a power unit control unit 210. The power unit control unit 210 includes a control element 304 for reducing/increasing the energy consumption/provision of the power unit 208 to/from the electricity distribution network 102, as well as a measuring device in the form of a smart meter 302 for example. The control element 304 may comprise a switch for connecting/disconnecting the power unit 208 to/from the electricity distribution network 102 and/or any electrical or electronic means allowing functional set points of a power unit 208 to alter the electrical consumption/provision by the power unit 208 (for example, a thermostat or humidity sensor, illumination sensor, pressure sensor and infra-red sensor, an inverter etc.).

The power unit control unit 210 also includes a data store, which stores profile information relating to the associated power unit 208. FIG. 3b shows an example of the content of the data store 310. For each power unit 208 recorded in the user database 406, there is stored an associated power unit identifier 512 for identifying the power unit 208, and/or a group to which the power unit 208 belongs, a further identifier 514, herein referred to as a “pseudo-identifier”, which also identifies the power unit 208, a location identifier 516 identifying a location associated with the power unit 208, user defined availability 518 and operating characteristics, such as an available contribution, such as an amount of energy 520 that the power unit 208 is available to make, and rate of contribution characteristics such as a power characteristic 522 of the unit e.g. a maximum or average power consumption/provision.

The power unit control unit 210 may be arranged to receive instructions from, and send meter measurements to, the control node 202 via a communications interface 306. As described above, the power unit control unit 210 may include a smart meter for making such measurement. Other methods of measuring contributions and/or characteristics of individual ones or groups of power units 208 may be used. For example, in some embodiments a method as described in WO2011/092265 may be used.

The power unit control unit 210 comprises a processor 308 arranged to control the functions of the smart meter 302 measuring device, the control element 304, and the communications interface 306. Although, the power unit control unit 210 is here shown as a separate device to the power units 208, in some embodiments, the power unit control units 210 are integral to the power units 208.

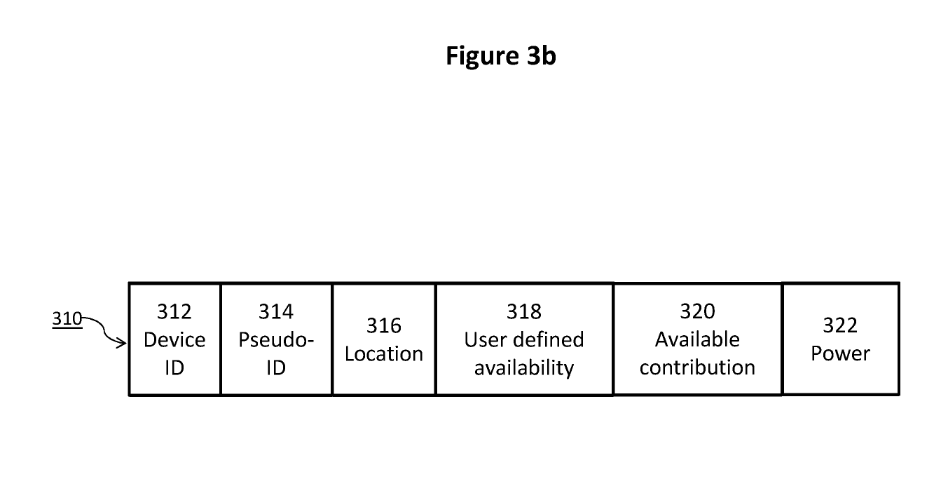

Exemplary components of a central node 200 are shown in FIG. 4. The central node 200 comprises a clock 402, a processing means in the form of a processor 404, a user database 406, a communications means in the form of a communications interface 408, and an input means in the form of a user interface 410.

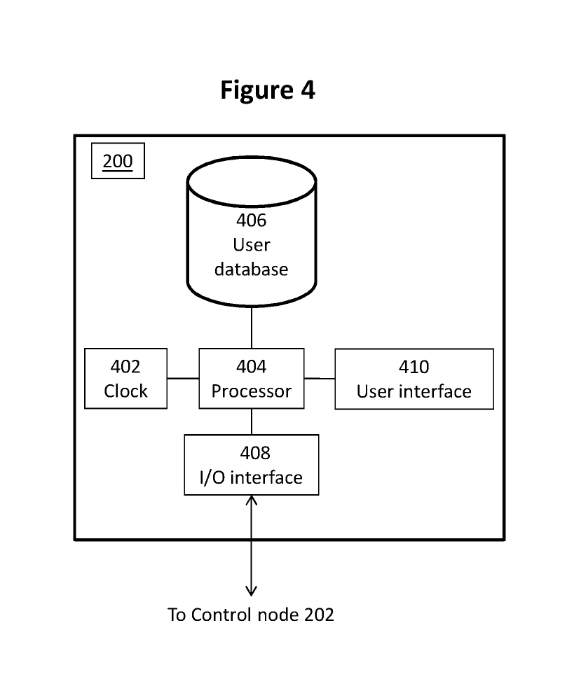

The user database 406 stores user accounts that contain user information. An exemplary record structure for the user database 406 is shown in FIG. 5. The user database 406 includes a user identifier 502, a name 504, an address 506, a password 508, and a device field 510 comprising a list of power units 208 owned by each user. For each power unit 208 recorded in the user database 406, there is stored information corresponding to the information stored in the data store 310 associated with the corresponding power unit i.e. an associated power unit identifier 512 for identifying the power unit 208, a pseudo-identifier 514, a location identifier 516 identifying a location associated with the power unit 208, user defined availability 518 and operating characteristics, such as an available contribution, such as an amount of energy 520 that the power unit 208 is available to make, and rate of contribution characteristics a power characteristic 522 of the unit e.g. a maximum or average real or reactive power consumption/provision. The operating characteristics may also define a device type (i.e. whether the device is an air conditioning unit, a refrigerator, or an immersion heater, for example) for the power unit 208, and other characteristics such as energy recovery characteristics. The user database 406 may also include bank details and/or contact details, such as an address or a telephone number of the user. Uses of the information stored in the user database 406 will be described in more detail below.

The user interface 410 is arranged to transmit and receive information to/from the user via a fixed or wireless communications means, such as ADSL, public cellular systems such as GSM, and/or 3G/4G or proprietary radio networks for example based on Zigbee™ or Power Line Communications The user database 406 can be accessed and updated by a user via the user interface 410 using authentication means and access control mechanisms, such as by correctly entering the password stored in the user database 406. The user is able to register one or more power units 208 to his/her user account, via the user interface 410 and/or update information stored in the user database 406 associated with the power units.

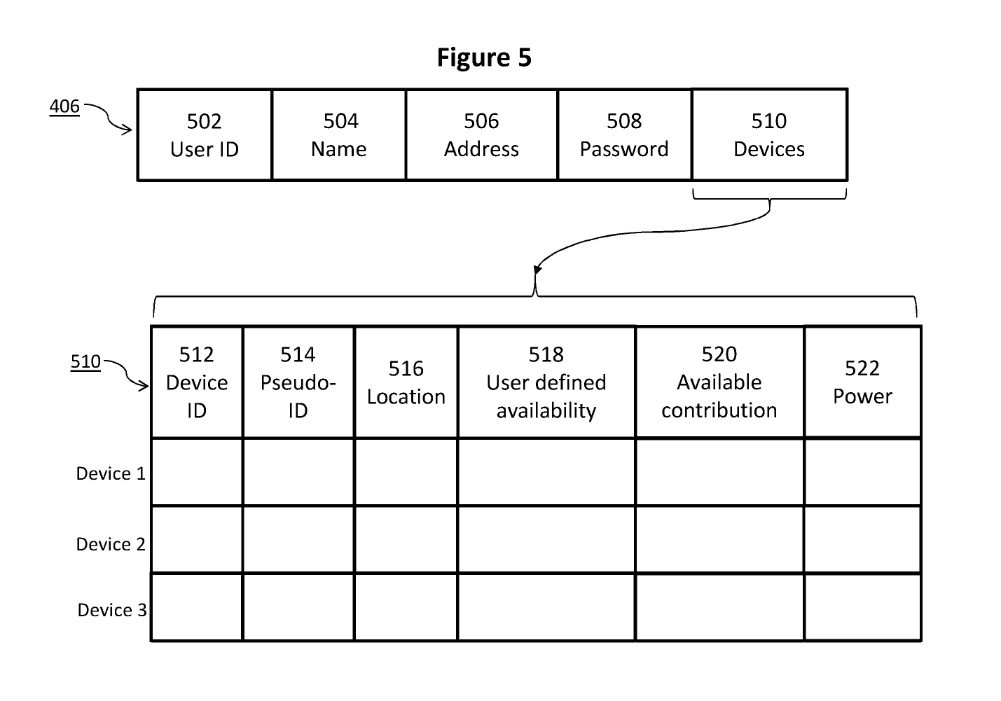

Exemplary components of a control node 202 are shown in FIG. 6. The control node 202 comprises a clock 602, a processing means in the form of a processor 604, a data store in the form of a device database 606, a communications means in the form of a communications interface 608, an input means in the form of an input device 610 and a memory 612 which may comprise a permanent memory (e.g. Read Only Memory (ROM) or temporary memory (e.g. Random Access Memory (RAM), Electrically Erasable Programmable Read Only Memory (EEPROM)). Although the memory 612 is shown separately to the device database 606, in some cases they may be combined, for example the device database 606 may be included in the memory 612.

The device database 606 contains a portion of the user database 406 that may be communicated to the control node 202 via a communications link that may be established between the communications interfaces 408, 608. These communications may be via fixed or wireless network, and comprise communications according to, for example, ADSL, public cellular systems such as GSM, and/or 3G/4G or proprietary radio networks for example based on Zigbee™ or Power Line Communications.

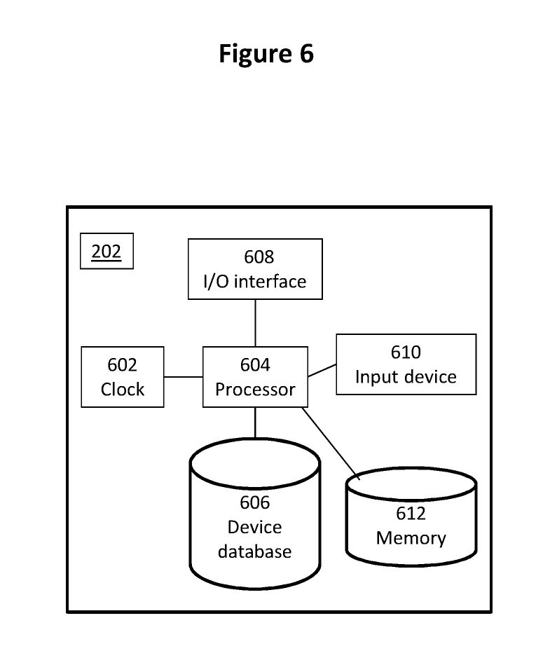

An exemplary record structure for the device database 606 is shown in FIG. 7. The device database 606 includes profile information relating to the power units 208, such as a device identifier 702, a pseudo-identifier 704, a device location 706, and device operating characteristics, such as user defined availability 708 and operating characteristics 720, 722, such as those described above in relation to the user database 206.

The input device 610 may be arranged to receive instructions from a party, such as a control scheme operator. The input device 610 may comprise a fixed input device such as a keyboard and/or mouse; additionally or alternatively it may comprises a communications interface for receiving instructions remotely via a fixed or wireless communications means, such as ADSL, public cellular systems such as GSM, and/or 3G/4G or proprietary radio networks for example based on Zigbee™ or Power Line Communications

The control node 202 is arranged to send requests to the power units 208 via the communication interface 608, as is described in more detail below.

These requests may be sent on a peer-to-peer basis using the device identifiers 702 stored in the device database 606; the device identifiers 702 may comprise a network address, such as an IP address enabling the power units 208 to be identified for the purposes of sending these requests.

Additionally or alternatively, communication from the control node 202 to the power units 208 may take the form of a broadcast. For example, the device database 606 may store one or more identifiers that identify groups to which power unit 208 is assigned. Transmissions intended for receipt by particular groups may include the identifiers associated with those groups to enable the power units 208 in the groups to determine whether they are intended to receive the transmission.

In some embodiments, power units 208 may be assigned to groups on the basis of one or more categorizations such as whether the power device 119 is a power consuming or power producing device, a categorization according to an amount of contribution that the power unit 208 is able to make, a categorization according to times of availability, and so on.

In some embodiments, the groups may be divided into one or more levels of sub-group, so as to provide greater granularity in the groups that may be selected.

Each of the identifiers associated with the groups and sub-groups to which a power unit 208 belongs may be dynamically changed to reflect changes to the suitability of the power unit 208 for membership to the groups and sub-groups for example; such changes may be determined by the control node 202, for example.

The power units 208 and/or their associated power unit control units 210, include a communications interface 306 for receiving requests and other information from, and sending information to, the control node 202. Herein, for conciseness, reference is made to power units 208 receiving and/or sending information, without reference being made to the power unit control units 210; however, where such reference is made, it will be understood that this also includes information being sent to and/or from an associated power unit control unit 210.

Some of the data stored in the device database 606 is received from the user database 406 at the central node 200, having being provided by a user; for example, the location indicators 516, and user defined device availability 518 are typically provided to the device database 606 in this way. The pseudo identifiers 514 mentioned above are used for this purpose. The pseudo identifiers 704 for a given power unit 208 stored in the device database 606 are the same as, or correspond to, the pseudo identifiers 514 for said given power unit 208 in the user database 406. When a change in the information stored in the user database 406 occurs, for example, due to the user changing information, such as an availability associated with one or more of his/her devices, via the user interface 410, the processor 404 of the central node 200 may communicate this change to the control node 202 via the communications interface 408. The change of data is communicated using the pseudo identifier of the corresponding power unit 208, enabling the processor 604 of the control node 202, to identify the relevant power unit 208 in the device database 606, and to make the necessary changes to the corresponding entry in the device database 606. Similarly, any data relating to a specific power unit 208 that is sent from the control node 202 to the central node 200 can be sent using the pseudo identifier to identify the relevant power unit 208.

Using the pseudo identifiers in this way improves data security, for the following reasons. Firstly, since the pseudo identifiers are different to the device identifiers which are used for communications between the control node 202 and the individual power units 208, it is more difficult for a nefarious third party monitoring communications to determine the location, or any other characteristic, of the power units 208 to which the communications relate. Secondly, the pseudo identifiers, in contrast to the device identifiers, do not themselves provide any information regarding e.g. a network location of the power unit 208 in question. This is advantageous in situations in which, for example, availability information of a power unit 208 is being communicated, since it is clearly undesirable to reveal to a third party who may be “listening in” on any communications both a location of a power unit 208, and a time when it is available to be controlled, since the latter may indicate that the property at which the power unit 208 is located will be unoccupied at that time. The pseudo identifiers may be varied frequently, for example daily, in order to further improve data security.

Communication between the central node 200 and the control nodes 202 are typically via the communication interfaces 408, 608.

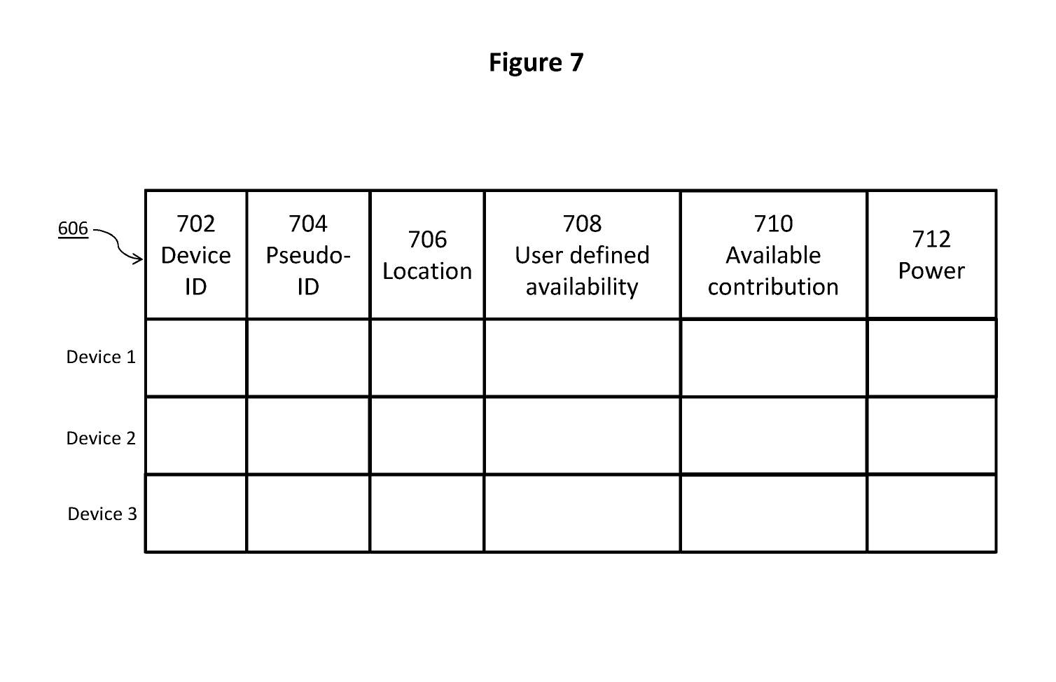

FIG. 8a illustrates a method by which the control node 202 controls one or more characteristics of the electricity flowing in the distribution grid 102. In the following discussion, reference is made to the control node 202 performing various actions. Although omitted for conciseness, it will be understood that the actions are typically performed by the processor 604 running software stored in the memory 612, in conjunction with the clock 602, where appropriate.

At step 800, the control node 202 determines a contribution to be made to one or more characteristics of electricity flowing in the electric power grid 102. Typically the contribution to be made is time-varying i.e. varies during the control period during which a contribution is to be made; however in some cases the contribution is not time-varying during the control period e.g. a square shape contribution. This determination may be based on monitoring of the one or more characteristics. In some embodiments, the control node 202 compares a monitored value with a threshold value and initiates a process to control same when the monitored value exceeds the threshold. For example, if the monitored characteristic is a grid frequency, the control node 202 may be arranged to initiate a control period if the monitored frequency deviates from a given range (e.g. 49 Hz to 51 Hz). In some arrangements, mathematical techniques (e.g. polynomial fitting techniques) may be employed to identify a future deviation in a monitored characteristic, and the process of FIG. 8 initiated in anticipation of the future deviation.

Alternatively or additionally, the contribution may be determined based on information received via the input device 610.

The contribution may be required in order to correct or compensate for a deviation in a characteristic. For example, based on the monitoring described above and/or instructions received via the input device 610, a current or future drop in electric power provision may be identified, compensation for which may require a contribution in the form of a reduction in demand. For example, a drop (or rise) in electric power provision by a renewable energy source, such as a wind or solar power generator, due to a change in weather conditions. Thus, changes in provision of electric power by such sources may be anticipated based on expected changes in the weather.

At step 802, power units 208 to be controlled in order to provide the contribution are selected. The selection may be performed on the basis of the profile information stored in the device database 606. For example, if the contribution to be made is a reduction in consumption, power units 208 may be selected, based on the operating characteristics information, such 208 that the combined total of the average consumption of the selected power units 208 is equal to the maximum required reduction in consumption. The selection may comprise selecting a group of power units 208 according to the categorizations described above, for example.

At step 804, a control function is generated providing a representation of the contribution determined at step 800.

At step 806, the control node sends, via the communications interface 608, instructions to the selected power units 208 (reference herein to information being sent to/from a power unit 208 includes the sending of data to/from an associated power unit control unit 210; similarly, reference to actions being performed by the power unit 208 includes the respective actions being performed by the power unit control unit 210). The instructions may be addressed using the device identifiers 702 stored in the device database 606 of the power units 208 selected at step 802, or may be broadcast to groups of devices using the group identifiers described above, for example. The instructions include an indication of the control function, and result in the power units 208 controlling power consumption and/or provision, as is now described with reference to FIG. 8b.

FIG. 8b shows an example of a single power unit 208 receiving instructions and controlling power provision/consumption in accordance with an embodiment of the present invention. At step 808 the power unit 208 receives the instructions sent by the control node 202 at step 806. The instructions include the control function generated at the control node 202.

At step 810 the power unit 208 retrieves profile information from the data store 310. Based on this profile information, and the received control function, the power unit 208 determines a contribution to be made by the power unit 208 during the control period defined by the control function at step 812. The retrieved profile information may include, for example, information indicating an amount of real or reactive energy that the power unit 208 is available to make during the control period. Alternatively, the power unit 208 may derive the amount of energy available to contribute from other information included in the data store 310, for example a power characteristic 322 of the power unit 208, time periods during the control period in which the device is available to make a contribution etc. The power unit 208 determines characteristics, such as a start time and/or time-distribution of its contribution based on the control function, as is described in more detail below.

At step 814 power flow to and/or from the control device is controlled in accordance with the contribution as determined at step 812 above.

Thus, in embodiments of the present invention, determination of characteristics of the contribution from individual power units 208 is performed by the power units 208 themselves, thereby relieving the control node 202 from the burden of coordinating the contributions from the individual power units 208. The control function generated by the control node 202 acts as a distribution function, such as a probability distribution function, according to which individual power units 208 control their contribution. The combined contribution from multiple power units 208 sums to a results equal or close to the overall desired contribution.

Since the control node 202 needs only to broadcast a single control function to multiple power units 208, rather than individual schedules to each individual device, the processing burden on the control node 202 is significantly relieved, as well as the burden on transmission resources.

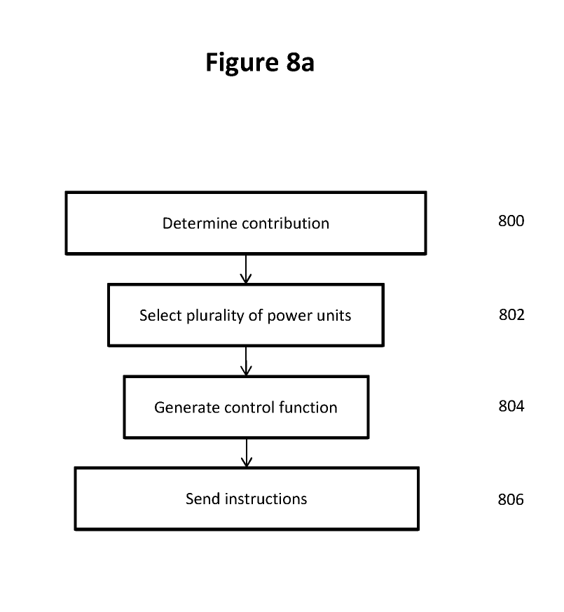

FIG. 9 is a graph showing an example of a control function f(t) representing a time-varying contribution that is required to be made to a characteristic of the electricity flowing in the electricity distribution grid 102. As described above, the contribution may be determined by the control node 202 based on monitoring of the grid and/or may be based on information received at the control node 202, for example from a network operator. In this example, we assume that the required contribution is a shift in power consumption/provision balance towards decreased power consumption of an amount varying over a time period T between zero and W(max).

The total required energy contribution is the area under of FIG. 9. The control node 202 selects power units 208 capable of collectively providing this total energy contribution during the control period (i.e. the period during which the control function applies), based on the profile information included in the device database 606, such as for example availability to contribute during the control period and the amount of power that the power unit 208 is available to provide during the control period.

Other criteria according to which the power units 208 may be selected are described below.

In the example of FIG. 9, the control function is generated at the control node 202 based on the determined contribution, by normalizing such that it has a proportion value of P=1 is provided at the point in time at which the determined contribution is equal to W(max). This normalization may alternatively be performed at the power unit 208.

Exemplary methods by which a power unit 208 may determine characteristics of its contribution are now described.

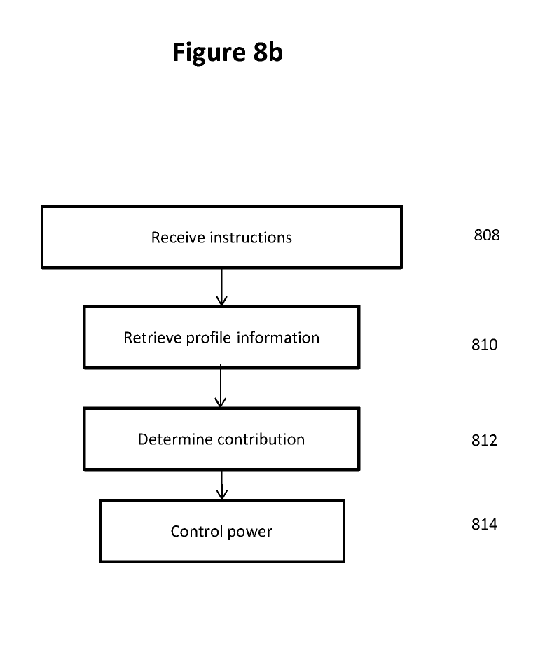

We describe a first method with reference to FIG. 10. In this method, the control function f(t) is integrated over the control period T to produce a further function P(t). FIG. 10 shows an example function P(t) which is the integral of the control function f(t) shown in FIG. 9, normalized so that its value varies between 0 and 1.

Having generated P(t), the power unit 208 generates a random number R; in the case of FIG. 10, the random number generated has a value of between 0 and 1. The power unit 208 then identifies the time tR [symbol] at which the function P(t) has the value R. This time value tR then serves as the basis for determining a timing characteristic of the contribution of the power unit 208, as is now described.

Typically, the value tR serves as the center of the distribution of the contribution. In the case of a power unit 208 capable of operating in two operating states (on and off), and for which the time required to switch between states is negligible, the contribution may take the form of a square wave; in this case the time tR may be set as the mid-point between the start and end times of the contribution.

If each of the power units 208 selected by the control node 202 use the above described method, a collective contribution having a magnitude and at least an approximate shape corresponding to the contribution represented by FIG. 9 is provided. This is because the probability of a given power unit 208 selecting a given time instance for making a contribution is proportional to the value of the control function at the given time instance, meaning that the sum contribution from a plurality of such power units 208 also follows, at least approximately, the shape of the control function. This method does not require any sophisticated control mechanisms at the power unit 208; it can be implemented using a simple on/off mechanism, as described above.

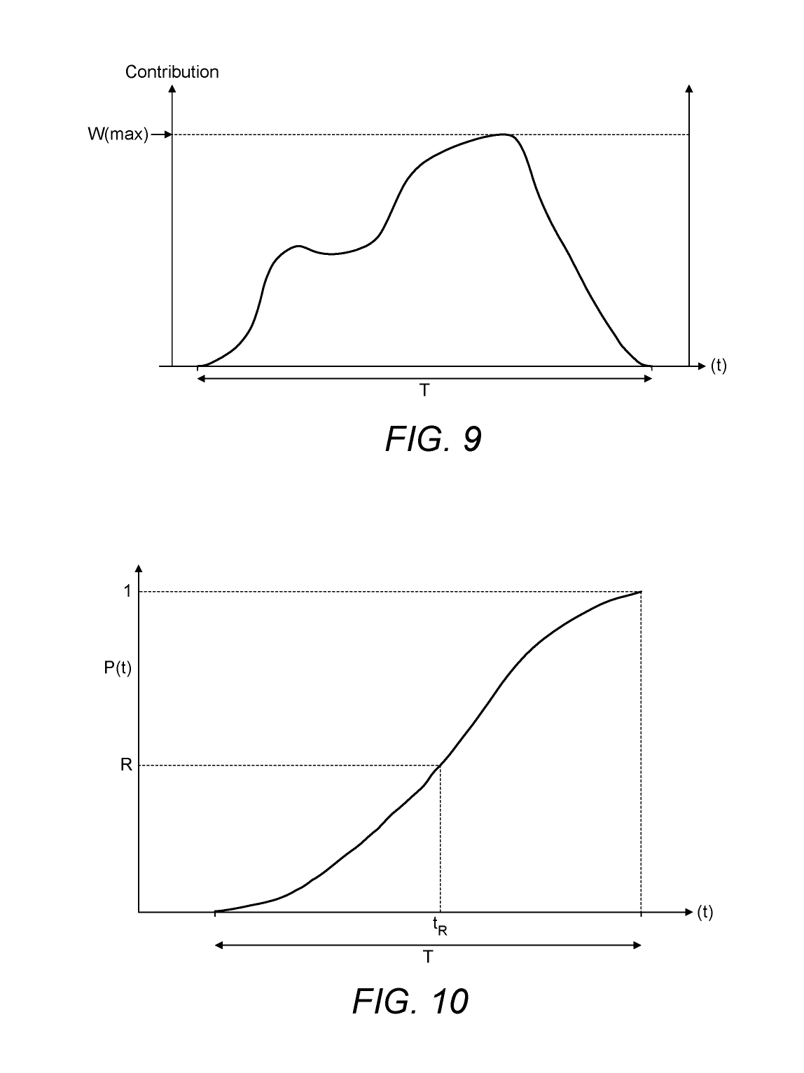

The fact that the power units 208 provide their contribution over a finite time span means that the shape of the collective response may “spread”, resulting in a shape of contribution which deviates from the desired shape. For example, FIG. 11 illustrates an example in which the desired contribution is a square wave; in this case, the finite length of the energy contribution from the selected power units 208 produces a contribution having sloped rather than vertical sides.

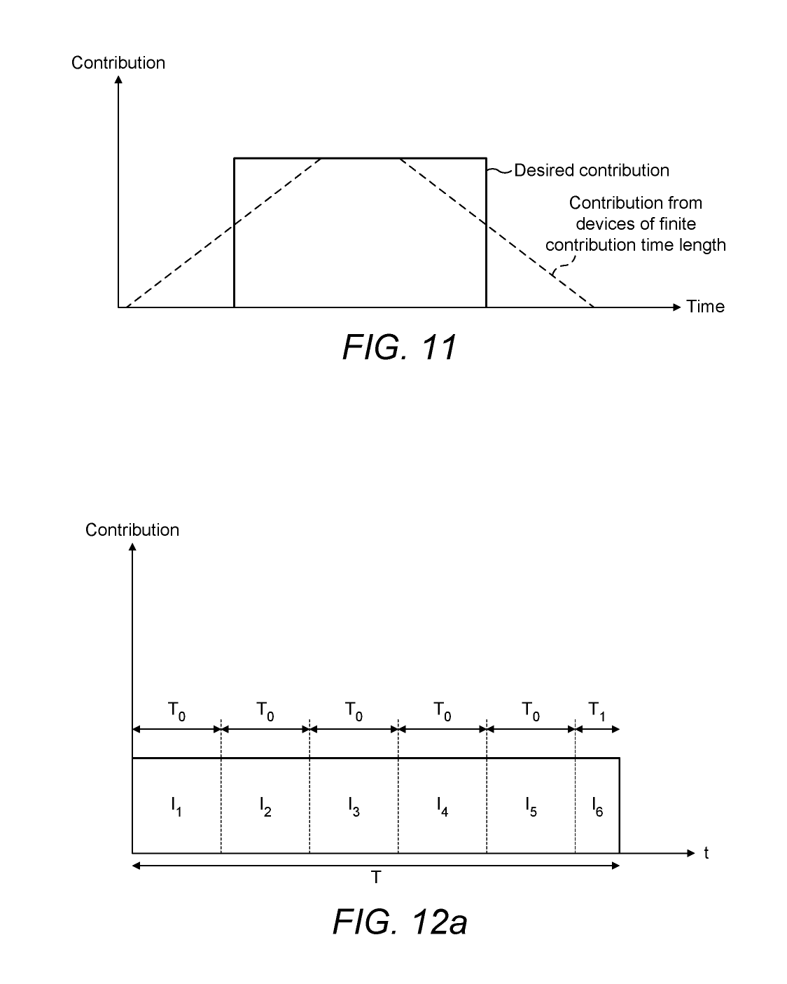

This may be addressed by the following approach. Instead of determining a time tR based on the technique described above, the power unit 208 divides the control period into a number of discrete intervals I1 . . . I6. FIG. 12a illustrates an example in which a power unit 208 receives a control function indicating a control period of length T. The power unit 208 divides the control period T into intervals of length T0, which may be equal to the length of time for which the power unit 208 is available to contribute. In the present example, T is not an exact multiple of T0, so one period is included having a length T1, less than T0. Although, in the present example, the power unit 208 has selected the final interval 16 to have the reduced length T1, the interval having reduced length T1 could be included at any point in the sequence of intervals.

Having divided the control period into separate intervals I1 . . . I6, the power unit 208 selects one of the intervals at random, and provides a contribution during the selected interval. In the case of the interval I6 having reduced length T1 being selected, if the power unit 208 is able to reduce the length of its contribution, it may do so such that the time length of the contribution is reduced to T1.

This method enables a plurality of power units 208 to collectively provide a square shaped energy contribution to the electricity distribution grid 102. Given a sufficiently large number of power units 208, the desired shape of contribution is provided by the combined contribution of the power units 208.

On receipt of a control function representing a desired square-shaped contribution, a power unit 208 may divide the control period into intervals according to its characteristics, such as a length of time the power unit 208 is available to contribute. The control node 202 is not required to have any particular data regarding these characteristics; the determination of the length of the intervals is performed by the power units 208 individually.

This method of dividing the control period into discrete intervals may be particularly suitable when the length of the control period is several multiples of the time period for which the power unit 208 is available to provide a contribution. A given power unit 208 may therefore select whether to use this latter method, or the method described above with reference to FIG. 10 based on the length of the control period relative to the length of the available contribution. For example, there may be a threshold value for the length of control period divided by the length of available contribution above which the method described with reference to FIG. 12a is used.

Where the shape of the desired contribution is not square, and cannot be approximated by same, the desired shape can be provided (or approximated) by dividing the desired contribution into multiple contributions, and representing each by a different control function, each of which is provided to a different group of power units 208.

An example is illustrated in FIG. 12b, in which the contribution shown in the left hand graph is divided into the three separate contributions shown on the right hand side. Each of the three contributions is represented by a separate control function and sent to separate groups of power units 208, selected by the control node 202. The combined contribution from the separate groups sums to the desired contribution shown in the left hand graph (or an approximation thereof).

In cases where the desired shape of the contribution cannot be easily formed from square-shaped groups, the control node 202 may “flatten” the shape so as to provide an approximation of the desired shape.

A further example of a power unit 208 controlling its contribution in accordance with an embodiment of the present invention is now described. In this further example, the power unit 208 identifies the value of the control function at a point in time, as indicated by the clock 402, for example. The power unit 208 then controls real or reactive power consumption or provision in accordance with the identified value, by varying an operating state of the power unit 208, so that it operates in the different operating states in a proportion of time, as defined by the control function.

As an example, we consider a power unit 208 which only has two operating states, on and off, in which it consumes a given amount of power in the on state and no power in the off state. In this case, given a value P of the control function at a given point in time, and assuming that the contribution to be provided by the power unit 208 is to decrease power consumption, the power unit 208 spends a proportion of time equal to P in the off state.

The power unit 208 may implement its contribution using a Pulse Width Modulation (PWM) method implemented as part of an inverter, for example. In this method, the power unit 208 is switched on and off, typically at a fast pace, with the proportion of time spent on or off being determined by the value of the control function at the relevant time. The pace of the switching is typically arranged such that it does not adversely affect the operation of the power unit 208. The pace of the switching may vary depending on the nature of the device; for example, for electric heating devices, the switching may be a few times per minute, whereas up to tens of thousands of times per second may be preferable for an electric motor.

While in the above example, the power unit 208 had only two operating states, power units 208 having any number of operating states may be used in embodiments of the present invention power. Where a power unit 208 has more than two operating states, there may be multiple different ways in which the power unit 208 can be controlled to produce the response defined by the control function.

As an example, we consider a power unit 208 which is a consumer of electric power having three operating states: state 1 in which no power is consumed; state 2 in which the power unit 208 consumes power at 50% of its maximum power consumption; and state 3 in which the power unit 208 consumes power at 100% of its maximum power consumption.

We assume that the value of the control function at a given time indicates that the power unit 208 should produce power at 75% of its maximum power consumption. In this case, this could be achieved by operating 50% of the time in state 2 and 50% of the time in state 3. Alternatively, it could be achieved by operating 25% of the time in state 1, and 75% of the time in state 3. Further alternatives using all three operating states are also possible, such for example, 10% of the time in state 1, 30% of the time in state 2 and 60% of the time in state 3. Any suitable combination of states may be used in embodiments of the present invention.

The start time of the PWM control may be randomized in order to prevent multiple power units 208 modulating in synchrony, which may produce undesirable variation in the power consumption/provision balance in the distribution grid 102. The randomization may be implemented by, for example, generating a random number between 0 and 1, and, on the basis of the number generated, selecting a start time within a predefined start interval (e.g. 1 ms).

In this further example, each power unit 208 provides a time-varying contribution in proportion to a value of the control function. The collective contribution from multiple power units 208 thus sums to a contribution having substantially the desired shape and magnitude of contribution as determined by the control node 202. A given power unit 208 contributing using the PWM method may contribute for the whole of the control period or for a proportion thereof, with different devices contributing at different times.

It should be noted that, for any group of power units 208 selected by the control node 202, different power units 208 of the group may use different methods to control their contribution. For example, one or more power units 208 of the group may provide a contribution using a method as described with reference to FIG. 10, one or more may use a method as described with reference to FIG. 12a and/or different ones of the one or more power units 208 may use the PWM method described above. In some cases, a power unit 208 may have the capability to implement multiple forms of the control methods described above, and select which method to use on a case by case basis, for example selecting at random or according to the environmental circumstances of the device or via factory or field programmed priorities or through control by the control node 202.

As mentioned above, the control node 202 may select power units 208 on the basis of an amount of contribution (e.g. real or reactive energy) that each power unit 208 is available to make during the control period.

In some cases, the power units 208 may be selected on the basis of power characteristics, such as a maximum real or reactive power that the power unit 208 is able to provide. When power units 208 are selected only on the basis of an available energy contribution, this may result in distortions in the shape at high peaks in the control function, if the power available from the selected power units 208 is insufficient to deliver the rate of contribution corresponding to those high peaks. Accordingly, the control node 202 may base the selection of power units 208 at least partly on a maximum power that the power units 208 may deliver, so that the total combined maximum power delivery is at least equal to the value at the peak of the control function.

The control node 202 is not generally required to have access to information indicating the particular method implemented by each power unit 208 for controlling its contribution. The method of provision of that contribution can be delegated to the individual power units 208.

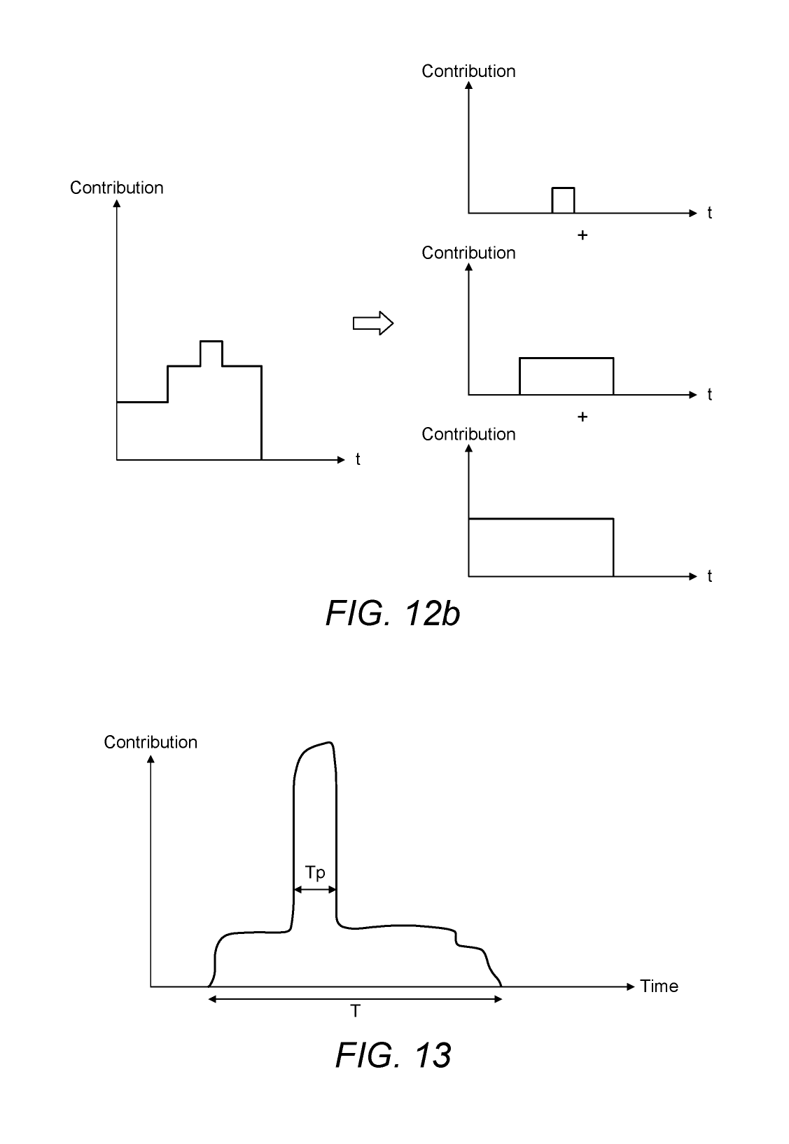

However, in some cases it may be advantageous for the control node 202 to have access to data indicating the control method implemented by the power units 208; this data may be stored as part of the operating characteristics stored in the device database 606, for example. This may enable distortions in the collective contribution to be inhibited or prevented in the case of control functions having high peaks, for example, as is now explained with reference to FIG. 13.

The data accessible by the control node 202 may indicate three types of power unit 208:

Power units 208 which are unable to modify the duration of their contribution;

Power units 208 which are able to alter the duration of their contribution, but cannot modify their instantaneous power (e.g. simple on/off devices);

Power units 208 which are able to modify their instantaneous power.

Power units 208 of type a) and b) may use the methods described above with reference to FIGS. 10 and 12a. In cases where the available time length of contribution of a power unit 208 is a high proportion of the length of the control period, in some cases it may be omitted from selection to avoid distortion of the profile shape. However, in some cases, for example where a degree of distortion is acceptable, such power units 208 may be included, and use the method described with reference to FIG. 10. Power units 208 of type c) may use the further method described above, as exemplified by the PWM method.

FIG. 13 shows an example of a control function having a total time length of T, and including a peak 1200 having a characteristic time length Tp For power units 208, of type a) and b), the control function may be sub-divided as described above with reference to FIG. 12b.

Power units 208 of type b) may limit the length of time over which they contribute, in order to use the method described with reference to FIG. 12a, so that they only contribute over a relatively small proportion of the control period.

For power units 208 of type c), in which the rate of contribution is controlled in proportion to the value of the control function, if the peak to average value of the control function is high, the power units 208 may be prevented from providing their full available contribution over the control period T.

Therefore power units 208 of both type b) and type c) may, in this scenario, contribute less than the total available contribution during the control period T. The control node 202, may take this into account when selecting power units 208. For example, the control node 202 may run a simulation of the contributions performed by available power units 208, taking into account operating characteristics such as the type of the power unit 208 (e.g. a), b) or c)) and/or an available duration of contribution, and select a combination of power units 208 able to provide both the desired total contribution and also the desired shape.

Using the methods described above, based on a control function representing a contribution to an electricity characteristic to be made by a group of power units 208, individual power units 208 determine characteristics of their individual contribution, based on profile information and the control function. This results in a collective contribution substantially according to the overall contribution represented by the control function. Since characteristics of the individual contributions are determined by the individual power units 208 themselves, the control node 202 is relieved from the burden concomitant with coordinating characteristics of the contribution from the individual power units 208. Further, because the same control function is broadcast to groups of power units 208, there is less burden on transmission resources compared to the case of sending individual instructions to individual power units 208.

Further saving on resources can be made according to a method as is now described.

The previous examples of a control function shown in FIGS. 9, 11, 12a, 12b and 13 comprise time-domain representations of a contribution. In some embodiments of the present invention the instructions sent from the control node 202 to the power units 208 may include a frequency-domain representation of the contribution. The control node 202 may perform a transform process to transform the time-domain representation into a frequency-domain representation. The transform process may comprise, for example, a Fourier transform or a wavelet transform. On receipt of instructions including the frequency-domain representation, a power unit 208 then performs a further transform process to transform the frequency-domain representation into a time-domain representation.

Transforming the time-domain representation into a frequency-domain representation may reduce the number of parameters that are required to define the control function. In order to define a time-domain representation, multiple parameters may be required, such as rise and fall times, start and stop times, values of the control function at different time instances, and so on. Particularly for complex control functions, the number of parameters required may be very large, placing a burden on the connection between the control node 202 and the power units 208.

Transforming to a frequency-domain representation allows the number of parameters used to define the control function to be reduced. The frequency-domain representation may comprise, for example a series of complex numbers, as in the case for a Fourier series. The number of terms in the series may be limited according to quality requirements, for example.

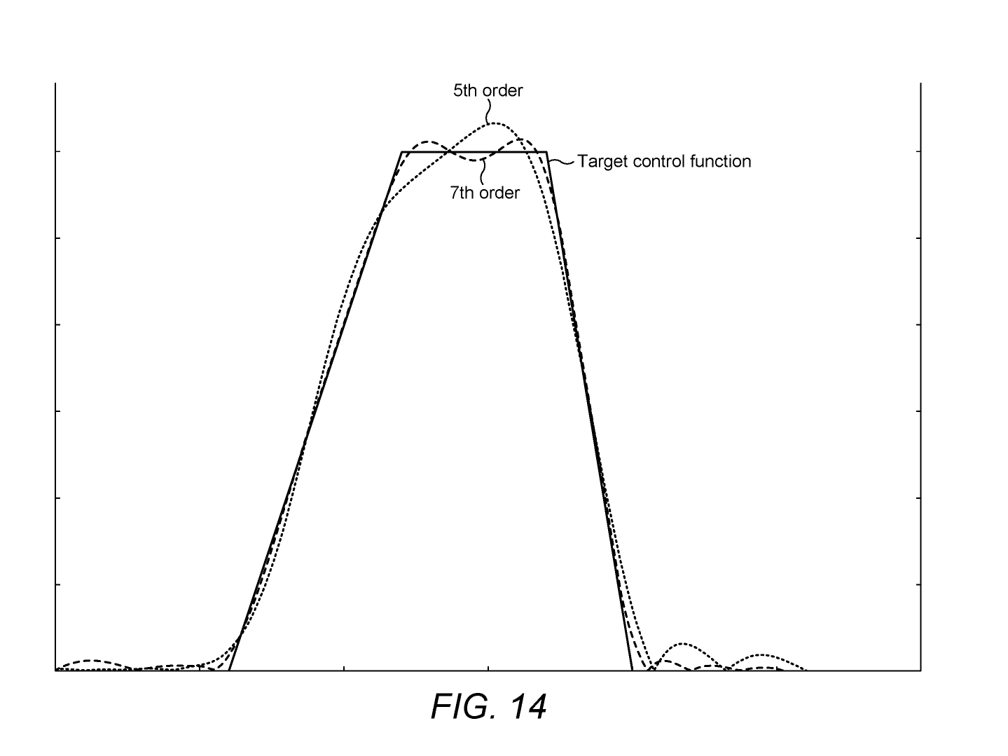

FIG. 14 shows an example of a target control function, along with the result of a transform to a time-domain representation at a power unit 208 of 5th and 7th order Fourier series frequency domain representations. It can be seen that the 7th order representation deviates less from the target control function than the 5th order representation. However, the 7th order representation requires more parameters than the 5th order representation, and therefore places a greater burden on the connection between the control node 202 and the power units 208. Accordingly the order of the representation may be varied in accordance with the quality of control function that is required.

The above example relates to Fourier transforms. However, it will be understood that other types of transform may be used, including other time-frequency transformations such as for example orthogonal and integral wavelet transforms which contain information similar to Fourier-transformations, but with the additional special properties of wavelets, which enable greater resolution in time at higher analysis frequencies of the basis function.

The methods of delivering control functions using a frequency-domain representation as described above, may be applied to other types of scheduling. For example, it may be used in situations in which the control node 202 specifies to each individual device the timings and/or other characteristics of its contribution, rather than delegating this to the individual devices according to the above methods.

While the above examples have been described with reference to a contribution to energy provision and/or consumption in the distribution grid, the methods described apply equally to contributions to other characteristics of electricity flowing in the electricity network 100, 102. For example, the methods described above could be used in cases where a contribution is required to a reactive power characteristic of the electricity, for example in conjunction with the methods described in WO2011/147852 A2, or where a variation in electric power consumption and/or provision is required in order to contribute to a frequency characteristic of the grid.

The techniques and methods described herein may be implemented by various means. For example, these techniques may be implemented in hardware (one or more devices), firmware (one or more devices), software (one or more modules), or combinations thereof. Hardware implementation may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a data store unit and executed by processors. The data store unit may be implemented within the processor or externally to the processor. In the latter case it can be communicatively coupled to the processor via various means, as is known in the art. Additionally, the components of the systems described herein may be rearranged and/or complemented by additional components in order to facilitate the achieving of the various aspects, etc., described with regard thereto, and they are not limited to the precise configurations set forth in the given figures, as will be appreciated by one skilled in the art.

The above embodiments are to be understood as illustrative examples of the invention. Further embodiments of the invention are envisaged. For example, it is described above that a user may interact with, and provide information to, the central node 200 via the user interface 310 of the central node 200. In some arrangements, the user may instead interact with the central node 200 using a user interface located elsewhere, or use an internet browser to communicate with the central node 200 via the internet. In some arrangements, the communication described as being performed by a user could instead be performed automatically, for example using a computer algorithm which could be adapted to access the users calendar, and/or other personal information to determine available times of devices associated with the user, for example.

Further, it was mentioned above that a control node 202 may store address data indicating a network address, such as IP address, of one or more power units 208 with which it communicates. In some embodiments, the power units 208 may have a unique identifier incorporated such as a subscriber identity module SIM card, for example, in which case the address data comprises an identity number of the given SIM card, such as an MSISDN number. In some cases communications between power units 208 and the control nodes 202 may take place by transmission of data along the power lines, known as Power Line Communication (PLC).

The central node 200 and the control node 202 may be implemented as a computerized device. They are described above as being implemented in discrete structures. However, the components and functions of these nodes, for example the user and device databases, may be implemented in a distributed manner, using a plurality of distributed physical structures.

Although the system shown in FIG. 2 includes a central node 200 and multiple control nodes 200, in some embodiment, no central node 200 is used and/or there may only be one control node 202.

Although reference is made above to an energy contribution and the like to the electricity distribution grid 102, embodiments of the invention apply equally to other parts of the electricity distribution network, such as the transmission grid 100.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of controlling one or more electricity characteristics of electricity flowing in an electric power grid, the electric power grid being connected to a distributed plurality of power units each arranged to consume electric power from and/or provide electric power to the electric power grid, the method comprising:
receiving, at a first power unit of the distributed plurality of power units, instructions to control power consumption from, and/or provision to, the electric power grid, the instructions including data indicative of a control function representing characteristics of a contribution to the one or more electricity characteristics to be made by the distributed plurality of power units during a control period;
retrieving, from a data store, profile information indicating one or more characteristics of a contribution that the first power unit is available to make during the control period;
determining, at the first power unit, based on the control function and the profile information, a first power unit contribution to the one or more electricity characteristics to be made by the first power unit during the control period; and
controlling power consumption from and/or provision to the electric power grid in accordance with the first power unit contribution.

2. The method of claim 1, wherein the contribution to the one or more electricity characteristics to be made by the distributed plurality of power units is a time-varying contribution.

3. The method of claim 1, comprising determining a timing characteristic of the first power unit contribution based on a random number generation process.

4. The method of claim 3, wherein the timing characteristic comprises a start time for initiating the first power unit contribution.

5. The method of claim 3, comprising determining the timing characteristic based on the control function.

6. The method of claim 5, comprising:
performing an integration process on the control function to generate an integrated control function;
generating a number using the random number generation process;
determining a time value at which the integrated control function has a value corresponding to the generated number; and
determining the timing characteristic based on the determined time value.

7. The method of claim 1, comprising:
dividing the control period into a plurality of intervals;
randomly selecting one of the plurality of intervals; and
controlling power consumption from and/or provision to the electric power grid during the selected interval.

8. The method of claim 7, wherein the plurality of intervals are selected based on a length of time during the control period for which the first power unit is available to provide the first power unit contribution.

9. The method of claim 1, wherein the first power unit is capable of operating in a plurality of operating states, a contribution to the one or more electricity characteristics varying according to the operating state, and the method comprises varying the operating state of the first power unit in accordance with a variation of the control function.

10. The method of claim 1, wherein the instructions comprise a frequency-domain representation of the desired time-varying contribution, and the method comprises performing a transform process to transform the frequency-domain representation into a time-domain representation.

11. The method of claim 10, wherein the transform process comprises performing at least one of a Fourier transform or a wavelet transform or a similar time-frequency domain transform.

12. The method of claim 1, wherein the one or more electricity characteristics comprises an energy characteristic.

13. The method of claim 1, wherein the profile information indicates one or more of an amount of energy available to contribute; a power consumption or provision characteristic of the first power unit; and a duration for which the power unit is available to provide the contribution.

14. A non-transitory computer-readable storage medium having computer readable instructions stored thereon, wherein, when executed by a processor, cause a computing device to perform a method of controlling one or more electricity characteristics of electricity flowing in an electric power grid, the electric power grid being connected to a distributed plurality of power units each arranged to consume electric power from and/or provide electric power to the electric power grid, the method comprising:
receiving, at a first power unit of the distributed plurality of power units, instructions to control power consumption from, and/or provision to, the electric power grid, the instructions including data indicative of a control function representing characteristics of a contribution to the one or more electricity characteristics to be made by the distributed plurality of power units during a control period;
retrieving, from a data store, profile information indicating one or more characteristics of a contribution that the first power unit is available to make during the control period;
determining, at the first power unit, based on the control function and the profile information, a first power unit contribution to the one or more electricity characteristics to be made by the first power unit during the control period; and
controlling power consumption from and/or provision to the electric power grid in accordance with the first power unit contribution.

15. A control device arranged to control a power unit for controlling one or more electricity characteristics of electricity flowing in an electric power grid, the electric power grid being connected to a distributed plurality of power units each arranged to consume electric power from and/or provide electric power to the electric power grid, the control device comprising:
at least one memory including computer program code; and
at least one processor in data communication with the memory, wherein the processor is configured to:
receive, at a first power unit of the distributed plurality of power units, instructions to control power consumption from, and/or provision to, the electric power grid, the instructions including data indicative of a control function representing characteristics of a contribution to the one or more electricity characteristics to be made by the distributed plurality of power units during a control period;
retrieve, from a data store, profile information indicating one or more characteristics of a contribution that the first power unit is available to make during the control period;
determine, at the first power unit, based on the control function and the profile information, a first power unit contribution to the one or more electricity characteristics to be made by the first power unit during the control period; and
control power consumption from and/or provision to the electric power grid in accordance with the first power unit contribution.

16. A method for controlling one or more real or reactive electricity characteristics of electricity flowing in an electric power grid, the electric power grid being connected to a distributed plurality of power units each arranged to consume electric power from and/or provide electric real or reactive power to the electric power grid, the method comprising:
determining, at a control system, a contribution to be made to one or more electricity characteristics by a plurality of power units each arranged to consume electric power from and/or provide electric real or reactive power to the electric power grid during a control period;
selecting, at the control system, a first plurality of the distributed plurality of power units based on the determined contribution and profile information relating to the first plurality of power units, the profile information including information relating to one or more operating characteristics of the power units;
generating, at the control system, a control function providing a representation of characteristics of the determined contribution; and
sending, via a communication means of the control system, instructions to the first plurality of power units to control power consumption and/or provision, the instructions including an indication of the control function.

17. The method of claim 16, wherein the determined contribution is a time-varying contribution.

18. The method of claim 16, wherein the determining the contribution comprises dividing a desired contribution into a plurality of contributions, and the method comprises selecting a different plurality of the distributed plurality of power units for each of the plurality of contributions.

19. The method of claim 16, wherein:
the determination of the contribution comprises determining a time-domain representation of the contribution; and
the generation of the control function comprises performing a transform process to generate a frequency-domain representation, such that the instructions comprise a frequency-domain representation of the control function.

20. The method of claim 16, wherein the transform process is performed on the basis of a precision requirement such that at least one characteristic of the frequency-domain representation varies according to the quality requirement.

21. The method of claim 19, wherein the transform process comprises at least one of a Fourier transform or a wavelet transform or a similar time-frequency domain transform.

22. The method of claim 16, wherein the one or more electricity characteristics comprises an energy characteristic.

23. The method of claim 16, wherein the profile information includes at least one of: an amount of energy to contribute during the control period; a power consumption or provision characteristic; a duration of availability to provide a contribution; and a method used by a given power unit to control its contribution.

24. A non-transitory computer-readable storage medium having computer readable instructions stored thereon, wherein, when executed by a processor, cause a computing device to perform a method for controlling one or more real or reactive electricity characteristics of electricity flowing in an electric power grid, the electric power grid being connected to a distributed plurality of power units each arranged to consume electric power from and/or provide electric real or reactive power to the electric power grid, the method comprising:
determining, at a control system, a contribution to be made to one or more electricity characteristics by a plurality of power units each arranged to consume electric power from and/or provide electric real or reactive power to the electric power grid during a control period;
selecting, at the control system, a first plurality of the distributed plurality of power units based on the determined contribution and profile information relating to the first plurality of power units, the profile information including information relating to one or more operating characteristics of the power units;
generating, at the control system, a control function providing a representation of characteristics of the determined contribution; and
sending, via a communication means of the control system, instructions to the first plurality of power units to control power consumption and/or provision, the instructions including an indication of the control function.

25. A control system for controlling one or more electricity characteristics of electricity flowing in an electric power grid, the electric power grid being connected to a distributed plurality of power units each arranged to consume electric power from and/or provide electric power to the electric power grid, the control system comprising:
a processing means; and
a communication means,
wherein the processing means is arranged to:
determine a contribution to be made to the one or more electricity characteristics by a plurality of power units each arranged to consume electric power from and/or provide electric power to the electric power grid during a control period;
select a first plurality of the distributed plurality of power units based on the determined contribution and profile information relating to the first plurality of power units, the profile information including information relating to one or more operating characteristics of the power units;
generate a control function providing a representation of characteristics of the determined time-varying contribution; and
send, via the communication means, instructions to the first plurality of power units to control power consumption and/or provision, the instructions including an indication of the control function.

26. A method for controlling one or more characteristics of electricity flowing in an electric power grid, the electric power grid being connected to a distributed plurality of power units each arranged to consume electric power from and/or provide electric power to the electric power grid, the method comprising:
determining, at a control system, a time-varying contribution to be made to the one or more characteristics by a plurality of power units each arranged to consume electric power from and/or provide electric power to the electric power grid during a control period;
selecting, at the control system, a first plurality of the distributed plurality of power units based on the determined contribution and profile information relating to the first plurality of power units, the profile information including information relating to one or more operating characteristics of the power units;
sending, via a communication means of the control system, instructions to each of the first plurality of power units to control power consumption and/or provision during the control period,
wherein the instructions sent to a given one of the first plurality power units include a frequency-domain representation of a time-varying contribution to be made by the given power unit to the one or more characteristics.

27. The method of claim 26, comprising:
determining a time-domain representation of the time-varying contribution to be made by the given power unit; and
performing a transform process to transform the time-domain representation into the frequency-domain representation.
